(19) United States
(12) Patent Application Publication
(10) Pub. No.: US 2026/0103601 A1
(43) Pub. Date: Apr. 16, 2026

(54) CARBON BLACK PELLETS CONTAINING CARBON NANOTUBES

(71) Applicant: Continental Carbon Co, Houston, TX (US)

(72) Inventors: Eduardo Vega, JR., Richmond, TX (US); Raymond Soufiani, Richmond, TX (US); Lashan M.H. De Silva, Dickinson, TX (US); Michael Brendan Rodgers, Leander, TX (US)

(21) Appl. No.: 19/355,316

(22) Filed: Oct. 10, 2025

Related U.S. Application Data
(60) Provisional application No. 63/705,817, filed on Oct. 10, 2024.

(51) Int. Cl. C09C 1/58

(52) U.S. Cl. CPC C09C 1/58; C01P 2002/88; C01P 2006/32; C01P 2006/40; C01P 2006/90

(57) ABSTRACT

Carbon black is pelletized to minimize dusting and improve factory handling qualities. Carbon nanotubes are added during this pelletizing step to further allow a higher level of dispersion and exfoliation of the carbon nanotubes when, along with carbon black, is compounded in rubber. This concept is applicable to pelletization of all grades of carbon black with all classes of carbon nanotubes including single wall carbon nanotubes, multi wall carbon nanotubes, and carbon nanotubes of variable lengths from 25 nanometers (nm) to 500 microns (μm), and any carbon nanotube organic functionality. The use of carbon black as a carrier of carbon nanotubes will mitigate carbon nanotube dusting with safety benefits, maximize dispersion in a rubber compound with processing benefits, and facilitate full attainment of rubber compound material properties through the inclusion of carbon nanotubes for performance benefits.

### I. BACKGROUND

This application claims priority to U.S. Ser. No. 63/705,817, filed Oct. 10, 2024, the contents of which are herein incorporated by reference. Compounded rubber has many unique characteristics not found in other materials, such as dampening properties, high elasticity, and abrasion resistance. Hence, in addition to tires, compounded rubber has found use in applications such as conveyor belts, large dock fenders, building foundations, hoses, automotive engine components, and a wide range of domestic appliances such as O-rings in appliances. The ingredients available to the materials scientist for formulating a rubber compound can be divided into five categories as follows:
1. Polymers, such as natural rubber (NR) or synthetic rubber, including styrene butadiene copolymers (SBR), polybutadiene (BR), ethylene propylene diene monomer (EPDM), polychloroprene rubber (CR), and nitrile rubber (NBR).
2. Filler systems and examples include carbon black, silica, clay, talc, and calcium carbonate.
3. Stabilizer system which includes antioxidants and antiozonants.
4. Vulcanization system which can include sulfur, accelerators or alternatively peroxides as an example.
5. Process aids and other additives such as oils and resins, homogenizing agents, pigments, and specialty materials to promote a specific property such as use of cobalt salts to increase rubber to brass coated wire adhesion.

Carbon black is the dominant filler in the compounding of rubber. It has three functions, i) improve the processing of rubber compounds by minimizing the elasticity sometimes described in processing and manufacturing of rubber products as compound “nerve,” ii) improve the mechanical properties of the rubber compound formulation such as tensile strength, and iii) optimize a formulation's cost.

The grades of carbon black are well defined; the material will fall into one of three classes depending on the manufacturing process, i) furnace grades, ii) thermal types, and iii) acetylene types. Excluding Austin Blacks produced from coal, all three types are within the scope of the present teaching. All three processes can have the same types of feedstocks, i.e., crude oil, tars, or natural gas including acetylene. In terms of global production, furnace type carbon black grades are the dominant type, due to the reinforcing properties in rubber compounds. Thermal grades are much less reinforcing though still find application in, for example, tires and specifically in tire innerliners. Acetylene grades, which have much larger particle sizes, find use in applications where greater thermal and electrical conductivity is required.

Furnace grades of carbon black fall into one of seven groups depending on the particle size (see Table I). These are as follows: super abrasion furnace (SAF), intermediate super abrasion furnace (ISAF), and high abrasion furnace (HAF) grades which are used, for example, in tread compounds or conveyor belt cover compounds, fast furnace (FF), fast extrusion furnace (FEF), general purpose furnace (GPF), and semi-reinforcing furnace (SRF) grades which are used in tire casing compounds and other components which are parts of industrial rubber products. Grades of carbon back within each of the seven groups are also well defined as shown in Table II and further described in the industrial standard, ASTM D1765.

The selection of any grade of carbon black for a tire component, or other compound used in an industrial product, will depend on the mission profile and performance envelope of the end product. For example, the carbon black grades, N110, N121, and N234 provide excellent abrasion resistance and are thus used in tire tread compounds. Due to the large particle size, grades such as N660 and N764 are suitable for use in sheets or liners where low permeability is required.

TABLE I
Tire and Industrial Products Carbon Black Categories

| | ASTM | Particle | |
|---|---|---|---|
| | Primary | Size | |
| Group | Grade | nm | Application |
| SAF | N110 | 11-19 | Treads |
| ISAF | N220 | 20-25 | Treads |
| HAF | N330 | 26-30 | Tread, Casing |
| FF | N475 | 30-39 | Industrial Products |
| FEF | N550 | 40-49 | Tire casing |
| | | | Industrial Products |
| GPF | N660 | 50-60 | Tire casing |
| | | | Industrial Products |
| SRF | N762 | 60-100 | Industrial Products |

TABLE II
Common Commercial Grades of Carbon Black

| | | | Compressed | | | |
|---|---|---|---|---|---|---|
| | | Oil | Oil | | | |
| ASTM | Iodine | Absorption | Absorption | NSA | | Tint |
| Designation | Number | Number | Number | Multipoint | STSA | Strength |
| N110 | 145 | 113 | 98 | 126 | 115 | 124 |
| N115 | 160 | 113 | 96 | 137 | 124 | 123 |
| N120 | 120 | 114 | 99 | 122 | 114 | 129 |
| N121 | 121 | 132 | 112 | 121 | 114 | 119 |
| N125 | 117 | 104 | 89 | 122 | 121 | 125 |
| N134 | 142 | 127 | 103 | 143 | 137 | 131 |
| N220 | 121 | 114 | 100 | 119 | 106 | 115 |
| N231 | 121 | 92 | 86 | 108 | 107 | 117 |
| N234 | 120 | 125 | 100 | 119 | 112 | 124 |
| N299 | 108 | 125 | 105 | 104 | 97 | 113 |
| N326 | 82 | 72 | 69 | 78 | 76 | 112 |
| N330 | 82 | 102 | 88 | 82 | 75 | 103 |
| N339 | 90 | 120 | 101 | 93 | 88 | 110 |
| N347 | 90 | 124 | 100 | 85 | 83 | 103 |
| N351 | 68 | 120 | 97 | 73 | 70 | 100 |
| N358 | 84 | 150 | 108 | 80 | 87 | 98 |
| N375 | 90 | 114 | 97 | 96 | 78 | 115 |
| N550 | 43 | 121 | 88 | 42 | 39 | |
| N630 | 36 | 78 | 62 | 32 | 32 | |
| N650 | 36 | 122 | 84 | 36 | 35 | |
| N660 | 36 | 90 | 75 | 35 | 34 | |
| N762 | 27 | 65 | 57 | 29 | 28 | |
| N772 | 30 | 65 | 58 | 32 | 30 | |
| N990 | | 38 | 37 | 9 | 8 | |
| N991 | | 35 | 37 | 8 | 8 | |

Improvement in carbon black properties and development of new grades for tires is constrained due to tire production factories capabilities, specifically the limited number of carbon black silos and towers to hold additional or new grades. Despite this, considerable effort in improving carbon black has been undertaken. Examples of methods to improve performance have included research on further optimizing carbon black particle size and structure, optimizing the particle surface chemistry, and functionalizing the carbon black particle with coupling agents such as organo-silanes, amines, and carboxylic acids.

A new approach is to add a new technology material via co-pelletization of the carbon black in manufacturing, thus ensuring a high level of dispersion both in the carbon black and in the final compound, thus achieving the new targeted material properties.

### II. SUMMARY

Blending and co-pelletization of carbon black with other materials to achieve specific properties avoids the use of developing and implementing complex chemistries on the carbon black surface. A carbon black's properties can be enhanced both with and without chemical modification via use of additives. Carbon nanotubes represent a new class of tire materials permitting significant performance improvement with no loss in secondary properties frequently experienced when new technology materials are developed.

Carbon nanotubes are available in several forms including single wall tubes (SWCNT), multi wall tubes (MWCNT), and of various lengths (FIG. 1). Single walled carbon nanotubes are an allotrope of sp² hybridized carbon, similar to fullerenes (FIG. 2). The structure can be thought of as a cylindrical tube with walls comprised of 6-membered carbon rings, as in graphite. The cylindrical tubes may have one or both ends capped with a hemisphere of a buckyball or fullerene structure.

Multi-wall carbon nanotubes can be further considered as two groups, those with 2 to 5 walls, and those with greater than 5 walls (FIG. 3).

Carbon nanotubes are significantly stronger than steel. Calculated values for tensile strengths of SWCNTs are ˜100 times greater than steel at 1/16th the weight, though the highest measured values are closer to half of the predicted theoretical strength due to defects in the structure, also observed in graphene. Electrical properties similarly show current carrying capacities of 10⁹ amp/cm², higher than those of copper or gold, and semiconducting species exhibit higher electron mobility than silicon. The thermal conductivity of a single nanotube may be comparable to that of diamond or in-plane graphite, which are generally thought to be among the highest measured thermal conductivity of materials at ambient temperatures

For illustrative purposes, FIG. 4 shows transmission electron micrographs of both single wall and multiwall carbon nanotubes.

Carbon nanotubes are known to be difficult to disperse, partly because of their tendency to form ropes or bundles due to natural Van der Waals attraction between the nanotubes. However, they can be dispersed in aqueous suspensions and solutions with the aid of suitable surfactants either as small bundles or as individual tubes.

In carbon black production, the carbon black is typically delivered in the form of pellets. It is first produced as fine powder which on completion of the manufacturing process water is added to carbon black powder, then pelletized, dried and packaged. The aqueous phase with or without a surfactant can facilitate addition of dispersed carbon nanotubes that can then be blended with carbon black in powder form and thus attain the required level of distribution in carbon black pellets. FIG. 5 illustrates a schematic of the carbon black manufacturing process. Additional description of the carbon black manufacturing process can be found in the text, Rubber Compounding, Chemistry and Applications, published by CRC Press, 2^{nd} edition.

### III. BRIEF DESCRIPTION OF THE DRAWINGS

The disclosure may take physical form in certain parts and arrangement of parts, aspects of which will be described in detail in this specification and illustrated in the accompanying drawings which form a part hereof and wherein:

FIG. 1 shows single wall and multi wall carbon nanotubes;

FIG. 2 shows a carbon nanotube wall configuration showing carbon 6-membered rings;

FIG. 3 shows multi-wall carbon nanotubes;

FIG. 4 shows multifunctional fibers of single wall and multi-wall carbon nanotubes with ultrahigh conductivity;

FIG. 5 shows a schematic of carbon black manufacture;

FIG. 6 shows a graph of TGA results for subject carbon nanotubes;

FIG. 7 shows a compound thermal conductivity increase with increase in carbon nanotube PHR;

FIG. 8 shows the effect of carbon nanotubes on Mooney Peak;

FIG. 9 shows the effect of carbon nanotubes on tensile strength;

FIG. 10 shows the effect of carbon nanotubes on compound hardness;

FIG. 11 shows the effect of carbon nanotubes on tear strength;

FIG. 12 shows the effect of carbon nanotubes on rebound resilience; and

FIG. 13 shows the increase of dynamic stiffness and E′ with carbon nanotubes.

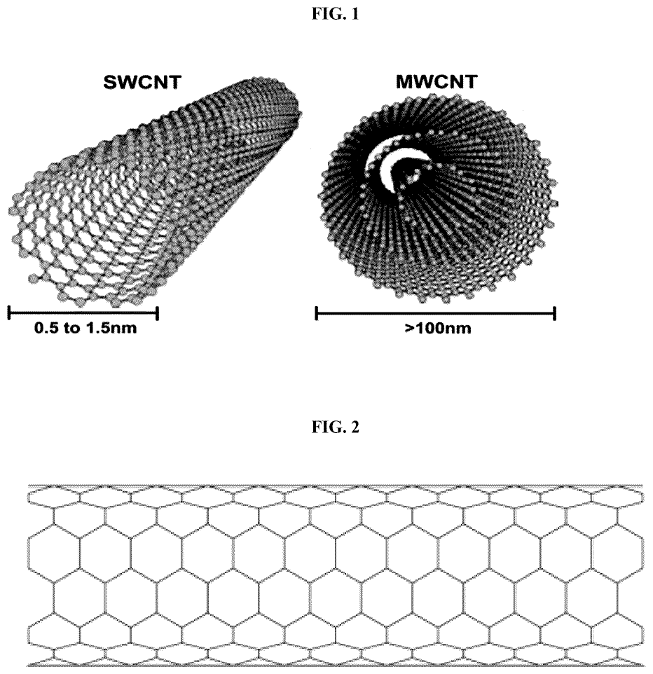

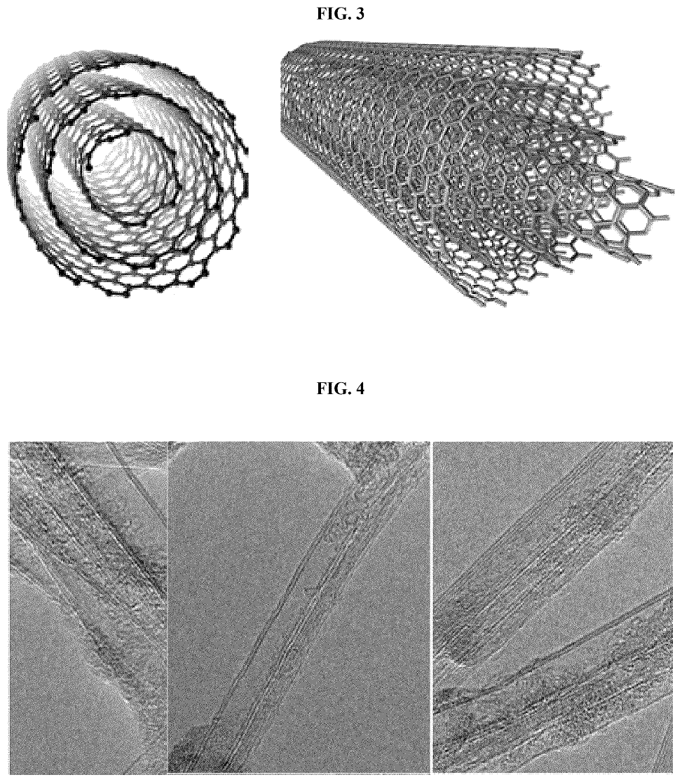

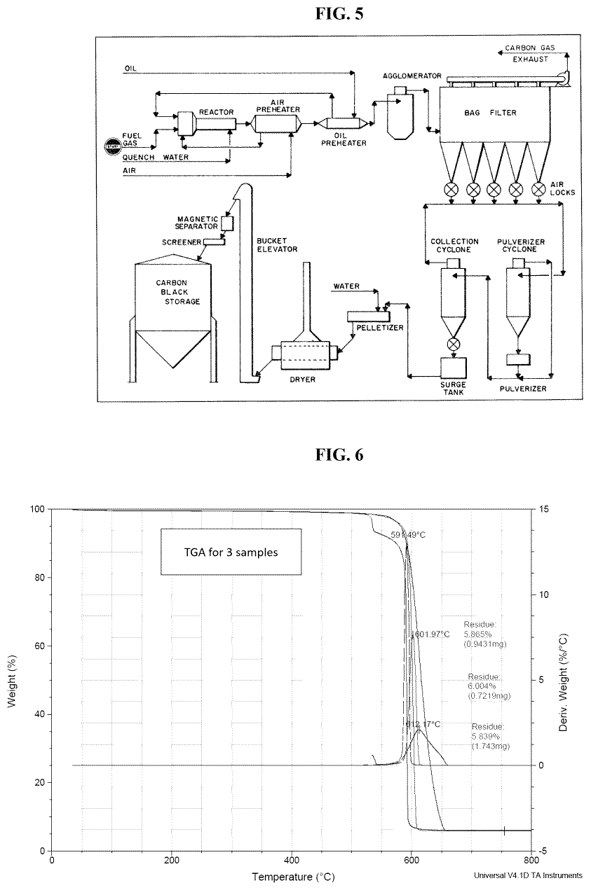

### IV. DETAILED DESCRIPTION

The addition of carbon nanotubes, both single wall SWCNT and multi wall MWCNT, as an aqueous dispersion prior to pelletization of the carbon black and then co-pelletization of carbon black and carbon nanotubes will address potential concerns of dust and industrial hygiene regarding free carbon nanotubes. A surfactant may be added if necessary to further facilitate dispersion in the aqueous phase. By adding and blending carbon nanotubes to the carbon black in dust form, it will achieve a high degree of dispersion and enhance the properties of the carbon black without negating the range of compound design variables required in the end-product. For example, addition of carbon nanotubes to carbon black and specifically grades represented by N100, N200, and N300 series (Table I) for tire compounds will facilitate improved mechanical properties such as tear strength with no shifts or losses in other secondary properties.

The co-pelletization of carbon black with carbon nanotubes will include all furnace grades of carbon black, thermal grades, and acetylene grades. Carbon nanotubes can be one of three types, single wall carbon nanotubes, multi wall carbon nanotubes, and carbon nanotubes of variable lengths from 25 nanometers (nm) to 500 microns (μm).

Carbon nanotubes dispersed in a carbon black matrix during the pelletization process would exist in one of three forms, i) as individual tubes, ii) carbon nanotubes aligned in parallel to each other, and iii) in a random orientation throughout the carbon black particles. In all cases, as the carbon black is blended with polymers and other compounding ingredients it will disperse in the compounded matrix. The ultimate mechanical properties of the compound will not be adversely affected by either of the three forms of nanotubes. Thus, the co-pelletization of carbon nanotubes and carbon black will achieve the following:
1. Full dust suppression,
2. Maximized dispersion when compounded, and
3. Full achievement of the theoretical compound properties achievable using carbon nanotubes, such as tensile strength.

Such improvements will be achievable for all elastomer systems, such as natural rubber (NR), styrene butadiene rubbers (SBR), polybutadiene (BR), nitrile rubbers (NBR, HNBR), ethylene propylene diene monomer (EPDM), polychloroprene (CR), and fluoro-elastomers (FKM and its derivatives, e.g., FFKM, FEPM, etc.).

### Example 1: Description of Subject Carbon Nanotubes

Thermogravimetric analysis (TGA) is used to assess the purity of the material. FIG. 6 represents a generic TGA result for carbon nanotubes.

In this instance the subject carbon nanotubes are defined as follows (Table III);

TABLE III
Carbon Nanotubes

| Property | Value |
|---|---|
| TGA Residual | 6 weight % |
| TGA 1^{st} Derivative Peak | 602° C. |
| Raman G/D (780 nm) | 4.4 |

### Example 2. Benefits of Co-Pelletization

The present teaching can use any ASTM defined grade of carbon black as described in Table II, i.e., any furnace type grade, any acetylene type of carbon black, or any thermal grade of carbon black. It also includes all types of carbon nanotubes. In the present teaching, the carbon black is co-pelletized with carbon nanotubes with the following benefits:
1. Eliminating dust due to carbon nanotubes with environmental benefits,
2. Maximizing the dispersion of carbon nanotubes in a rubber compound where the carbon black—carbon nanotubes complex is produced and applied,
3. Eliminating the need for an additional item in rubber goods factory raw materials inventory, and
4. Enhancing safety through simplification of materials handling systems.

### Example 3. Composition

The present teaching can use any ASTM defined grade of carbon black as described in Table II, i.e., any furnace type grade, any acetylene type of carbon black, or any thermal grade of carbon black. It also includes all types of carbon nanotubes. The amount of carbon nanotubes incorporated into the carbon black pellets will be from about 0.1 weight percent to about 30 weight percent, including between about 1 and about 10 weight percent.

### Example 4. Alignment of Compounded Carbon Nanotubes

Orientation of carbon nanotubes parallel to the direction of grain in a compound affects dispersion, tear strength, tensile strength, and impact resistance. Grain is the general alignment of polymer chains and rubber compounding ingredients in the direction a sheet of rubber is produced either by extrusion or calendaring. Polymer chains will align themselves in the direction of extrusion, this being manifested as marginal increase in tensile strength compared to those perpendicular to the direction of extrusion, calendaring, or grain. The carbon nanotubes will align in this direction of flow or grain. This phenomenon is well established in tire and industrial manufacturing and is sometimes referred to as the “direction of the grain.” By preparing the carbon nanotubes as part of the carbon black pellets, a higher degree of alignment is obtained, thus facilitating dispersion and subsequent increase in tear strength, tensile strength, and impact resistance.

Similarly, fatigue resistance will be increased when compounded samples are subjected to cyclic fatigue due to the reinforcing effect of carbon nanotubes aligned parallel to the direction of grain.

### Example 5. Electrical and Thermal Properties

Orientation of carbon nanotubes parallel to the direction of grain in a compound will further enhance electrical and thermal conductivity. Thermal conductivity increases with carbon black to carbon black particle contact, this phenomenon increasing significantly above the percolation point, i.e., the geometric phase transition when a critical fraction of the network of disconnected carbon black clusters merge into significantly larger connected or spanning clusters. This connection is further promoted by carbon nanotubes increasing connectivity and this increasing thermal transmission.

### Example 6. Rapid Gas Decompression

Use of carbon black co-pelletized with carbon nanotubes also results in improved compound tear strength and fatigue resistance, which can improve properties of high-performance O-rings, gaskets, and seals used in oil and gas applications by increased resistance to rapid gas decompression.

Rapid gas decompression occurs when gases are absorbed into elastomer seals until an equilibrium is reached. Though swelling will occur there will be no damage as long as the system is pressurized. If there is a rapid pressure release due to a blowdown event or opening of a valve, the pressure differential occurring between the gas trapped in the elastomer seal and the surrounding environment causes gas expansion which then can inflate the material resulting in blistering, cracking, and rapid failure of the seal.

Uniform dispersion of carbon nanotubes in the seal, O-ring, or gasket compound will increase reinforcement thus increasing resistance to failure caused by the described pressure release condition. This improvement in reinforcement will be manifested as an increase in low strain modulus.

### Example 7. In-Compound Properties

ASTM D3192 provides a model compound formulation ideal for fundamental research and materials screening. It contains natural rubber, carbon black with a suggested grade, ASTM N330 described in ASTM D1765, and a vulcanization system consisting of stearic acid, zinc oxide, the accelerator benzothiazyl disulfide (MBTS), and sulfur. This formulation was adapted but with the carbon black set at 60 phr. This was used as a control and is reproduced in Compound 1 (Table III). Carbon nanotubes replaced the carbon black on a part-for-part basis as shown in Compounds 2 and 3 in Table III. The tensile strength, compound hardness, and electrical and thermal conductivity were measured.

The composition was prepared by first forming a carbon black—carbon nanotube blend and then added to natural rubber masterbatch in a micromixer. This was then used for compounding the final formulation as described in Compound 1 (Table III).

As carbon nanotube content increased, low strain modulus at 5%, 10%, and 50% increased, suggesting carbon nanotubes function as a nucleating agent in strain induced crystallization of natural rubber. This is consistent with other findings using graphene (see Ozbas et al, J Polymer Sci: Polymer Physics. 50 P718-723 2012, Pascall et al, American Chemical Society Rubber Div Paper B16, Pittsburgh 2021). This demonstrates carbon nanotubes may be equally effective as nucleating agents. Furthermore, hardness and thermal conductivity increased, which is desirable in reducing tire curing times with productivity improvements, and in products such as tire curing bladders.

Adding carbon nanotubes to fine carbon black before pelletizing, the pelletizing operation being typically part of the carbon black manufacturing process, will further improve dispersion and further enhancement of properties would be expected.

TABLE IV
In-Compound Properties (Notes 1, 2)

| | | 1 | | |
|---|---|---|---|---|
| Compound | | Control | 2 | 3 |
| Natural Rubber | TSR 10 | 100.00 | 100.00 | 100.00 |
| Carbon Black | N330 | 60.00 | 57.40 | 47.00 |
| Carbon Nanotubes | CCNT | 0.00 | 2.60 | 13.00 |
| Stearic Acid | | 3.00 | 3.00 | 3.00 |
| Zinc Oxide | | 5.00 | 5.00 | 5.00 |
| MBTS | | 0.60 | 0.60 | 0.60 |
| Sulfur | | 2.50 | 2.50 | 2.50 |
| TOTAL | | 171.10 | 171.10 | 171.10 |
| Tensile Strength | MPa | 25.14 | 24.69 | 22.78 |
| Elongation at break | % | 402 | 378 | 342 |
| 5% Modulus | MPa | 0.63 | 0.69 | 1.01 |
| 10% Modulus | MPa | 0.90 | 1.00 | 1.43 |
| 50% Modulus | MPa | 2.10 | 2.35 | 3.23 |
| 100% Modulus | MPa | 4.17 | 4.39 | 5.68 |
| 200% Modulus | MPa | 11.07 | 11.47 | 12.76 |
| 300% Modulus | MPa | 18.51 | 19.44 | 20.20 |
| Hardness | Shore A | 70.00 | 73.00 | 75.00 |
| Electrical | mS/m | 68.61 | 59.44 | 68.44 |
| Conductivity | | | | |
| Thermal Conductivity | W/m · K | 0.323 | 0.333 | 0.367 |

Note: 1. Electrical conductivity reported in milli Siemens per meter (mS/m) and is the unit of conductance or reciprocal of Ohms which is the unit of resistance
2. Thermal conductivity is reported in Watts per meter Kelvin (W/m·K)

### Example 8. Increase in Compound Carbon Nanotube Content

As a further example, carbon nanotube content was increased to 21 phr and 30 phr, replacing carbon black on a part for part basis, as seen in Table IV.

The study further demonstrated that low strain modulus continued to increase though tensile strength and conventional modulus at 300% strain dropped. Such trends may be expected with addition of nucleating agents to a natural rubber based compound. With no change in electrical conductivity, the percolation point may have been achieved with carbon nanotubes at approximately 13.0 phr. However, thermal conductivity continues to increase in a linear manner with a correlation coefficient of 0.99 as illustrated in FIG. 6.

TABLE V
Increasing amounts of Carbon Nanotubes

| | | 1 | | | | |
|---|---|---|---|---|---|---|
| Compound | | Control | 2 | 3 | 4 | 5 |
| Natural Rubber | TSR 10 | 100.00 | 100.00 | 100.00 | 100.00 | 100.00 |
| Carbon Black | N330 | 60.00 | 57.40 | 47.00 | 39.00 | 30.00 |
| Carbon Nanotubes | CCNT | 0.00 | 2.60 | 13.00 | 21.00 | 30.00 |
| Stearic Acid | | 3.00 | 3.00 | 3.00 | 3.00 | 3.00 |
| Zinc Oxide | | 5.00 | 5.00 | 5.00 | 5.00 | 5.00 |
| MBTS | | 0.60 | 0.60 | 0.60 | 0.60 | 0.60 |
| Sulfur | | 2.50 | 2.50 | 2.50 | 2.50 | 2.50 |
| TOTAL | | 171.10 | 171.10 | 171.10 | 171.10 | 171.10 |
| Tensile Strength | MPa | 25.14 | 24.69 | 22.78 | 21.09 | 17.63 |
| Elongation | % | 402 | 378 | 342 | 286 | 287 |
| at break | | | | | | |
| 5% Modulus | MPa | 0.63 | 0.69 | 1.01 | 1.23 | 1.43 |
| 10% Modulus | MPa | 0.90 | 1.00 | 1.43 | 1.63 | 2.00 |
| 50% Modulus | MPa | 2.10 | 2.35 | 3.23 | 3.83 | 4.74 |
| 100% Modulus | MPa | 4.17 | 4.39 | 5.68 | 6.54 | 7.96 |
| 200% Modulus | MPa | 11.07 | 11.47 | 12.76 | 13.20 | 13.93 |
| 300% Modulus | MPa | 18.51 | 19.44 | 20.20 | 20.43 | — |
| Hardness | Shore A | 70.00 | 73.00 | 75.00 | 75.00 | 77.00 |
| Electrical | mS/m | 68.61 | 59.44 | 68.44 | 66.28 | 68.83 |
| Conductivity | | | | | | |
| Thermal | W/m · K | 0.323 | 0.333 | 0.367 | 0.396 | 0.426 |
| Conductivity | | | | | | |

### Example 9

As a further example, carbon nanotubes were evaluated in a model compound containing bromobutyl rubber and N660 grade carbon black. Such formulations may be found in, for example, tire innerliners and other applications where low permeability is required. Two sets of compounds were prepared, Compound 1 which is a control or reference formulation and 4 compounds, Compounds 2, 3, 4, and 5, containing co-pelletized carbon black grade N660 and carbon nanotubes (CNT) with increasing CNT levels in the compound from 2, to 4, to 10, to 15 PHR. In addition, a second set of four compounds were prepared, Compounds 6, 7, 8, and 9, where the carbon black and CNT were added as free flowing, thus allowing a comparison of freely added CNT to co-pelletized CNT in carbon black. The formulations are in Table VI.

The formulations, as presented in Table VI, were prepared and tested including an analysis conducted using the rubber process analyzer (RPA). The RPA instrument allowed an assessment of compound processing and vulcanization properties.

TABLE VI
Model Bromobutyl Innerliner Compounds with Co-Pelletized Carbon
Nanotubes and N660 Carbon Black (Compounds 2-5) versus where Carbon
Nanotubes and Carbon Black are Added Free (Compounds 6-9)

| Compound | 1 | 2 | 3 | 4 | 5 | 6 | 7 | 8 | 9 |
|---|---|---|---|---|---|---|---|---|---|
| BIIR (Grade | 100.00 | 100.00 | 100.00 | 100.00 | 100.00 | 100.00 | 100.00 | 100.00 | 100.00 |
| 2222) | | | | | | | | | |
| CB in Pellet | | 60.00 | 60.00 | 60.00 | 60.00 | | | | |
| Pellet | | 2.00 | 4.00 | 10.00 | 15.00 | | | | |
| CNT Level | | | | | | | | | |
| Carbon Black | 60.00 | | | | | 60.00 | 60.00 | 60.00 | 60.00 |
| N660 | | | | | | | | | |
| CNT [free | | | | | | 2.00 | 4.00 | 10.00 | 15.00 |
| addition] | | | | | | | | | |
| Naphthenic oil | 8.00 | 8.00 | 8.00 | 8.00 | 8.00 | 8.00 | 8.00 | 8.00 | 8.00 |
| Struktol 40MS | 7.00 | 7.00 | 7.00 | 7.00 | 7.00 | 7.00 | 7.00 | 7.00 | 7.00 |
| Escorez 1102 | 4.00 | 4.00 | 4.00 | 4.00 | 4.00 | 4.00 | 4.00 | 4.00 | 4.00 |
| Stearic acid | 1.00 | 1.00 | 1.00 | 1.00 | 1.00 | 1.00 | 1.00 | 1.00 | 1.00 |
| Zinc Oxide | 1.00 | 1.00 | 1.00 | 1.00 | 1.00 | 1.00 | 1.00 | 1.00 | 1.00 |
| MBTS | 1.25 | 1.25 | 1.25 | 1.25 | 1.25 | 1.25 | 1.25 | 1.25 | 1.25 |
| Sulfur | 0.50 | 0.50 | 0.50 | 0.50 | 0.50 | 0.50 | 0.50 | 0.50 | 0.50 |
| Total | 182.75 | 184.75 | 186.75 | 192.75 | 197.75 | 184.75 | 186.75 | 192.75 | 197.75 |

Rubber Process Analyzer (RPA at 160 C.)

| | | | | | | | | | |
|---|---|---|---|---|---|---|---|---|---|
| ML, dNm | 1.25 | 1.49 | 1.84 | 3.55 | 6.12 | 1.64 | 1.73 | 2.72 | 3.81 |
| MH, dNm | 5.17 | 6.04 | 7.36 | 12.50 | 17.69 | 6.40 | 7.12 | 10.52 | 13.91 |
| MH-ML, dNm | 3.93 | 4.55 | 5.52 | 8.94 | 11.57 | 4.76 | 5.39 | 7.80 | 10.10 |
| TS2, min | 5.35 | 4.82 | 4.10 | 2.45 | 1.17 | 4.34 | 4.27 | 3.42 | 2.47 |
| TC10, min | 2.13 | 2.00 | 1.82 | 1.07 | 0.67 | 1.86 | 1.91 | 1.64 | 1.26 |
| TC50, min | 4.79 | 4.48 | 4.70 | 4.37 | 3.49 | 5.40 | 4.82 | 5.00 | 4.83 |
| TC90, min | 10.46 | 10.94 | 10.35 | 10.33 | 9.60 | 9.75 | 10.47 | 11.15 | 11.17 |
| CRI | 12.00 | 11.19 | 11.72 | 10.80 | 11.20 | 12.67 | 11.68 | 10.52 | 10.09 |

For the nine compounds, the RPA measured compound minimum torque (ML) increased as the CNT amount in the compound increased for both co-pelletized CNT and freely added CNT. This can be attributed to a loading effect when added to the carbon black PHR. There was no significant change in vulcanization kinetics with increasing CNT amount suggesting no reformulation of the vulcanization system might be required. The addition of CNT at low levels may therefore be considered as a drop in not requiring cure system reformulation.

### Example 10

Co-pelletization of carbon nanotubes (CNT) with carbon black can have benefits such as easier CNT handling in the factory and compound quality improvement such as better raw material dispersion. The Mooney viscosity was measured to further explore the effects. Two measurements were obtained on compounds containing 2, 4 and 10 phr CNT, i) the Mooney peak viscosity obtained when the test rotor starts, and ii) the final viscosity obtained after 4 minutes (ML1+4). The results are in Table VII.

TABLE VII
Moony Peak and Viscosity ML1 + 4

| | | 2 | 3 | 4 | 6 | 7 | 8 |
|---|---|---|---|---|---|---|---|
| Compound | 1 | Pellets | Pellets | Pellets | Free | Free | Free |
| Polymer: | 100.00 | 100.00 | 100.00 | 100.00 | 100.00 | 100.00 | 100.00 |
| BIIR | | | | | | | |
| CB CNT in | | 60.00 | 60.00 | 60.00 | | | |
| Pellet | | | | | | | |
| CNT Level | | 2.00 | 4.00 | 10.00 | | | |
| Carbon Black | 60.00 | | | | 60.00 | 60.00 | 60.00 |
| CNT | | | | | 2.00 | 4.00 | 10.00 |
| [free add.] | | | | | | | |

Mooney Viscosity ML1 + 4

| | | | | | | | |
|---|---|---|---|---|---|---|---|
| Max Peak @ | 76.60 | 80.49 | 88.88 | 115.67 | 82.92 | 85.32 | 103.35 |
| 100° C. | | | | | | | |
| ML 1 + 4 @ | 57.86 | 62.72 | 68.51 | 96.48 | 64.81 | 67.59 | 85.99 |
| 100° C. | | | | | | | |

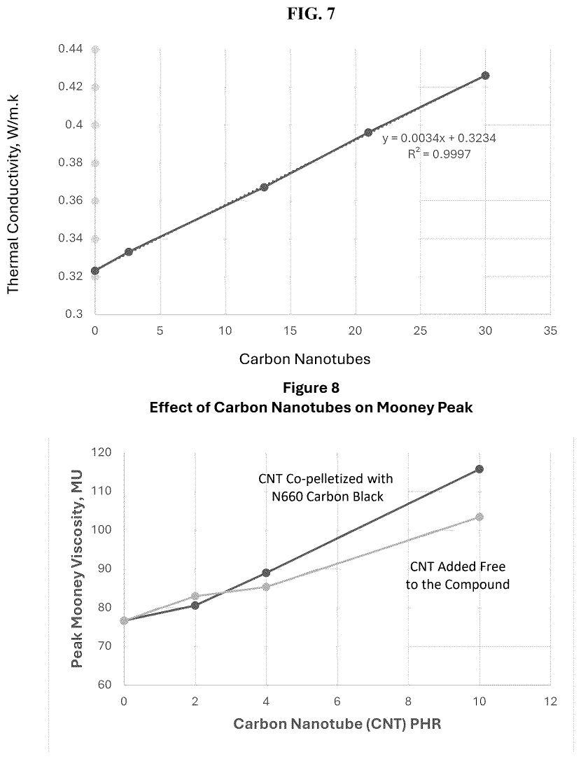

The Peak Mooney viscosity as described in the text, Rubber Compounding from CRC Press (2015), and ASTM D1646 can provide an indication of bound rubber and thus the amount of reinforcement. FIG. 8 shows the effect of adding CNT co-pelletized with N660 carbon lack versus freely added CNT. The effect of adding CNT freely caused a significant increase in Mooney Peak value showing the degree of reinforcement was greatest for co-pelletized CNT and carbon black. It is concluded that use of CNT in co-pelletized carbon black will increase compound stiffness and compound filler reinforcement to a greater degree than freely added CNT.

### Example 11

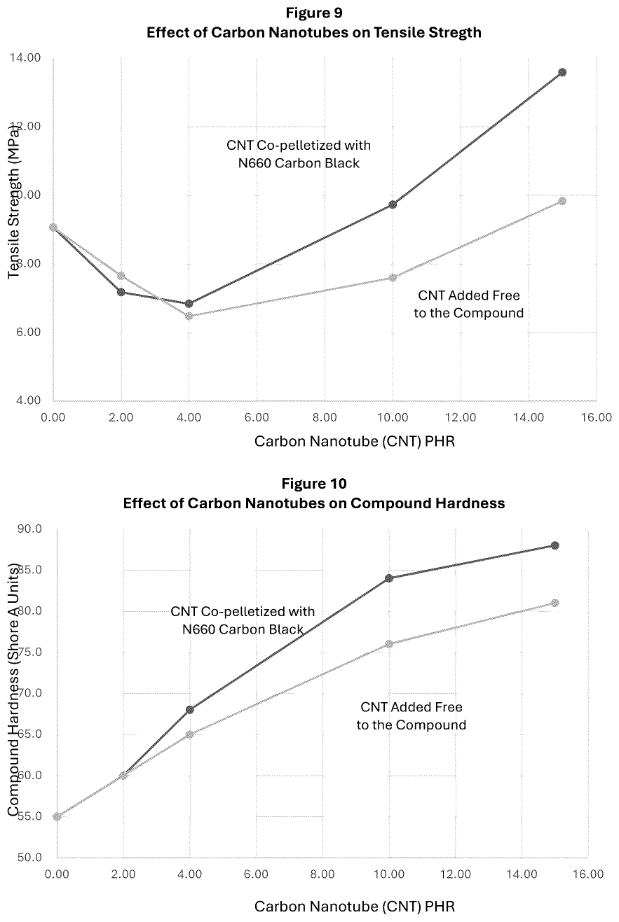

The compounds in Example 9 were further tested for tensile strength, hardness, and tear strength (Table VIII). Adding carbon nanotubes leads to a large increase in compound tensile strength as measured following ASTM D412. Similarly tear strength as measured following the method described in ASTM D624 Die B, also increased. The degree of improvement in tensile strength was much greater with co-pelletized CNT versus when CNT was added as a powder, as seen in FIG. 9.

TABLE VIII
Co-Pelletized Carbon Nanotubes and N660 Carbon Black (Compounds
2-5) Versus Freely Added CNT and Mechanical Properties

| Compound | 1 | 2 | 3 | 4 | 5 | 6 | 7 | 8 | 9 |
|---|---|---|---|---|---|---|---|---|---|
| Polymer: | 100.00 | 100.00 | 100.00 | 100.00 | 100.00 | 100.00 | 100.00 | 100.00 | 100.00 |
| BIIR | | | | | | | | | |
| CB CNT | | 60.00 | 60.00 | 60.00 | 60.00 | | | | |
| in Pellet | | | | | | | | | |
| CNT Level | | 2.00 | 4.00 | 10.00 | 15.00 | | | | |
| Carbon Black | 60.00 | | | | | 60.00 | 60.00 | 60.00 | 60.00 |
| CNT | | | | | | 2.00 | 4.00 | 10.00 | 15.00 |
| [free add.] | | | | | | | | | |

Tensile Strength

| | | | | | | | | | |
|---|---|---|---|---|---|---|---|---|---|
| Tensile, MPa | 9.06 | 7.17 | 6.83 | 9.72 | 13.58 | 7.65 | 6.47 | 7.59 | 9.83 |
| Elongation, % | 805 | 671 | 461 | 178 | 100 | 602 | 482 | 195 | 126 |
| M100%, MPa | 1.32 | 2.11 | 3.47 | 8.83 | 13.58 | 2.25 | 2.94 | 6.37 | 9.56 |
| M200%, MPa | 2.13 | 3.39 | 5.07 | 6.02 | 0.00 | 3.78 | 4.48 | 7.56 | 0.00 |
| M300%, MPa | 3.21 | 4.53 | 6.11 | 0.00 | 0.00 | 5.19 | 5.54 | 0.00 | 0.00 |
| Hardness | 55.0 | 60.0 | 68.0 | 84.0 | 88.0 | 60.0 | 65.0 | 76.0 | 81.0 |
| (Shore A) | | | | | | | | | |

Tear Strength

| | | | | | | | | | |
|---|---|---|---|---|---|---|---|---|---|
| Die B KN/m | 46.3 | 41.9 | 46.2 | 63.3 | 90.4 | 47.2 | 43.4 | 48.4 | 62.2 |

Similarly for compound hardness. As the CNT level increased compound Shore A hardness increased (FIG. 10). Compared to the free addition of CNT, increase CNT level via use of co-pelletized CNT was much greater and a near 10% increase shown for Compound 5 containing 15 phr CNT. Co-pelletizing with N660 carbon black is much more effective than the free addition of carbon black and CNT.

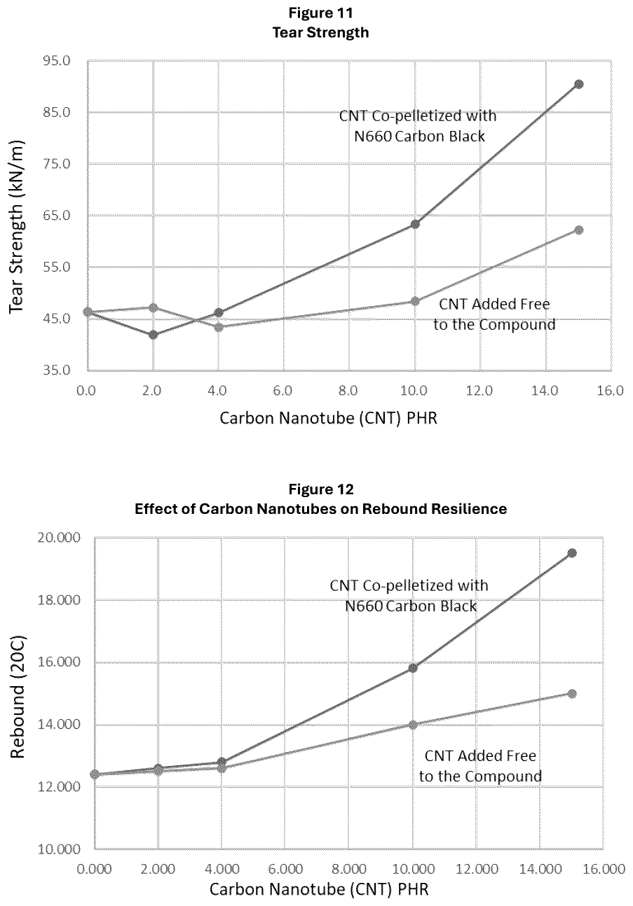

Tear strength also increased with increasing CNT level; the higher values being attained with co-pelletized CNT (FIG. 11). At 15 phr the effect of co-pelletization was to increase tear strength by nearly 50% compared to free addition of CNT.

### Example 12

Hysteresis and resilience are important property parameters for rubber compounds. Rubber resilience refers to the ability of rubber materials to return to their original dimensions after a deformation force. It is thus a measure of how well a rubber material can absorb and release energy during deformation. Resilience can be easily measured using the rebound test measured as described in ASTM D7121 and also via dynamic mechanical analysis (DMA). Rebound of compounds containing co-pelletized CNT are better than compounds containing free addition of CNT as shown in Table IX and FIG. 12, with high values being achieved for co-pelletized CNT compounds.

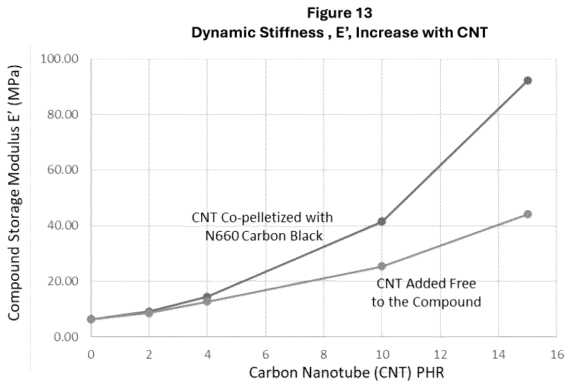

The improved resilience is due to the increased dynamic compound stiffness. Storage modulus under tension was measured using a TA Instruments electro-force Dynamic Mechanical Analyzer. As CNT level increased, storage modulus increased. The degree of increase was greatest for co-pelletized CNT in carbon black. Correspondingly as the storage modulus increased the tangent delta decreased. The tangent delta decreased despite the increase in loss modulus. The loss modulus increase was attributed to the loading effect and not an increase in material hysteresis such as what would be due to an increase in compound glass transition temperature. It is noted that tangent delta at 60 C is a predictor of rolling resistance. The lower the value the better. Tangent delta is a ratio of loss modulus, E″, to storage modulus, E′, or E″/E′, and thus the higher the E′ with little change in E″, then the lower will be the tangent delta and thus the lower predicted rolling resistance potential. Therefore, it was concluded that use of carbon nanotubes co-pelletized with carbon black can reduce or improve rolling resistance due to the increase in compound dynamic modulus (FIG. 13).

TABLE IX
CNT addition and Effect on Resilience

| Compound | 1 | 2 | 3 | 4 | 5 | 6 | 7 | 8 | 2 |
|---|---|---|---|---|---|---|---|---|---|
| Polymer: | 100.00 | 100.00 | 100.00 | 100.00 | 100.00 | 100.00 | 100.00 | 100.00 | 100.00 |
| BIIR | | | | | | | | | |
| CB in Pellet | | 60.00 | 60.00 | 60.00 | 60.00 | | | | |
| Pellet | | 2.00 | 4.00 | 10.00 | 15.00 | | | | |
| CNT Level | | | | | | | | | |
| Carbon Black | 60.00 | | | | | 60.00 | 60.00 | 60.00 | 60.00 |
| N660 | | | | | | | | | |
| CNT [free | | | | | | 2.00 | 4.00 | 10.00 | 15.00 |
| addition] | | | | | | | | | |
| Rebound at | 12.40 | 12.60 | 12.80 | 15.80 | 19.50 | 12.50 | 12.60 | 14.00 | 15.00 |
| 20° C. | | | | | | | | | |

DMA at 20 C.

| | | | | | | | | | |
|---|---|---|---|---|---|---|---|---|---|
| E′ | 14.00 | 20.10 | 30.10 | 77.70 | 165.00 | 17.90 | 25.60 | 47.10 | 79.90 |
| E″ | 7.06 | 9.80 | 15.30 | 27.10 | 38.10 | 8.78 | 11.80 | 20.50 | 29.60 |
| tan delta | 0.506 | 0.488 | 0.509 | 0.348 | 0.231 | 0.490 | 0.460 | 0.436 | 0.371 |

DMA at 60 C.

| | | | | | | | | | |
|---|---|---|---|---|---|---|---|---|---|
| E′ | 6.26 | 9.09 | 14.40 | 41.40 | 92.10 | 8.50 | 12.70 | 25.30 | 44.00 |
| E″ | 1.43 | 2.07 | 3.43 | 8.93 | 17.10 | 1.91 | 2.93 | 5.75 | 9.51 |
| tan delta | 0.229 | 0.227 | 0.239 | 0.216 | 0.186 | 0.224 | 0.231 | 0.227 | 0.215 |

Clause 1—A compound including carbon black powder and carbon nanotubes, wherein the carbon nanotubes have a length from about 25 nm to about 100 microns, wherein the carbon nanotubes are chosen from the group consisting of single wall carbon nanotubes and multi-wall carbon nanotubes.

Clause 2—The compound of clause 1, wherein the carbon nanotubes have a length from about 25 nm to about 50 microns.

Clause 3—The compound of clauses 1 or 2, wherein the carbon nanotubes align parallel to a direction of grain of the compound.

Clause 4—The compound of clauses 1-3, wherein the carbon nanotubes are about 0.1 weight percent to about 30 weight percent.

Clause 5—The compound of clauses 1-4, wherein the carbon nanotubes are about 1.0 weight percent to about 10 weight percent.

Clause 6—The compound of clauses 1-5, further comprising natural rubber.

Clause 7—The compound of clauses 1-6, wherein the natural rubber is about 100 PHR, the carbon black powder is about 30 PHR to about 60 PHR, and the carbon nanotubes are about 2.60 PHR to about 30 PHR.

Clause 8—The compound of clauses 1-7, further including stearic acid, zinc oxide, dibenzothiazyl disulfide, and sulfur.

Clause 9—The compound of clauses 1-8, further including naphthenic oil, a homogenizing agent, and an aliphatic hydrocarbon resin.

Clause 10—A method of producing carbon black pellets, the method including the steps of adding an aqueous dispersion of carbon nanotubes, prior to pelletization, to powdered carbon black and co-pellitizing the carbon nanotubes and the carbon black powder.

Clause 11—The method of clause 10, wherein the carbon nanotubes have a length from about 25 nm to about 50 microns.

Clause 12—The method of clauses 10 or 11, wherein the carbon nanotubes align parallel to a direction of grain of the compound.

Clause 13—The method of clauses 10-12, wherein the carbon nanotubes are about 0.1 weight percent to about 30 weight percent.

Clause 14—The method of clauses 10-13, wherein the carbon nanotubes are about 1.0 weight percent to about 10 weight percent.

Clause 15—The method of clauses 10-14, further including the step of adding natural rubber to the aqueous dispersion and powdered carbon black.

Clause 16—The method of clauses 10-15, wherein the natural rubber is about 100 PHR, the carbon black powder is about 30 PHR to about 60 PHR, and the carbon nanotubes are about 2.60 PHR to about 30 PHR.

Clause 17—The method of clauses 10-16, further including the step of adding stearic acid, zinc oxide, dibenzothiazyl disulfide, and sulfur to the natural rubber.

Clause 18—The method of clauses 10-17, further including step of adding naphthenic oil, a homogenizing agent, and an aliphatic hydrocarbon resin to the natural rubber.

The examples described herein are illustrative and non-exhaustive. One of ordinary skill in the art may recognize that numerous further combinations and permutations of the present specifications are possible. Each of the aspects of the present disclosure described above may be in combination in any permutation to define the aspects disclosed herein. Not all elements are necessary in every aspect, and additional elements beyond those described may be included within the scope of the present disclosure. The specification and drawings are to be regarded in an illustrative rather than a restrictive sense.

1. A compound comprising:
carbon black powder; and
carbon nanotubes, wherein the carbon nanotubes have a length from about 25 nm to about 100 microns, wherein the carbon nanotubes are chosen from the group consisting of single wall carbon nanotubes and multi-wall carbon nanotubes.

2. The compound of claim 1, wherein the carbon nanotubes have a length from about 25 nm to about 50 microns.

3. The compound of claim 2, wherein the carbon nanotubes align parallel to a direction of grain of the compound.

4. The compound of claim 3, wherein the carbon nanotubes are about 0.1 weight percent to about 30 weight percent.

5. The compound of claim 4, wherein the carbon nanotubes are about 1.0 weight percent to about 10 weight percent.

6. The compound of claim 1, further comprising natural rubber.

7. The compound of claim 6, wherein the natural rubber is about 100 PHR, the carbon black powder is about 30 PHR to about 60 PHR, and the carbon nanotubes are about 2.60 PHR to about 30 PHR.

8. The compound of claim 7, further comprising:
stearic acid;
zinc oxide;
dibenzothiazyl disulfide; and
sulfur.

9. The compound of claim 8, further comprising:
naphthenic oil;
a homogenizing agent; and
an aliphatic hydrocarbon resin.

10. A method of producing carbon black pellets, the method comprising the steps of:
adding an aqueous dispersion of carbon nanotubes, prior to pelletization, to powdered carbon black; and
co-pellitizing the carbon nanotubes and the carbon black powder.

11. The method of claim 10, wherein the carbon nanotubes have a length from about 25 nm to about 50 microns.

12. The method of claim 11, wherein the carbon nanotubes align parallel to a direction of grain of the compound.

13. The method of claim 12, wherein the carbon nanotubes are about 0.1 weight percent to about 30 weight percent.

14. The method of claim 13, wherein the carbon nanotubes are about 1.0 weight percent to about 10 weight percent.

15. The method of claim 10, further comprising the step of:
adding natural rubber to the aqueous dispersion and powdered carbon black.

16. The method of claim 15, wherein the natural rubber is about 100 PHR, the carbon black powder is about 30 PHR to about 60 PHR, and the carbon nanotubes are about 2.60 PHR to about 30 PHR.

17. The method of claim 16, further comprising the step of:
adding stearic acid, zinc oxide, dibenzothiazyl disulfide, and sulfur to the natural rubber.

18. The method of claim 17, further comprising step of:
adding naphthenic oil, a homogenizing agent, and an aliphatic hydrocarbon resin to the natural rubber.
